(19) United States
(12) Patent Application Publication
(10) Pub. No.: US 2018/0247647 A1
(43) Pub. Date: Aug. 30, 2018

(54) VOICE CONTROL

(71) Applicant: Lenovo (Beijing) Co., Ltd., Beijing (CN)

(72) Inventors: Xiaoping ZHANG, Beijing (CN); Yongwen SHI, Beijing (CN); Yonggang ZHAO, Beijing (CN); Zhepeng WANG, Beijing (CN)

(21) Appl. No.: 15/905,983

(22) Filed: Feb. 27, 2018

(30) Foreign Application Priority Data
Feb. 27, 2017 (CN) 201710109298.3

(51) Int. Cl. G10L 15/22; G10L 15/26

(52) U.S. Cl. CPC G10L 15/22; G10L 2015/088; G10L 2015/223; G10L 15/26

(57) ABSTRACT

A method includes receiving a speech input, activating a voice control function to recognize a subsequent speech input and output a feedback corresponding to the subsequent speech input in response to the speech input being determined as a first wake-up-word (WUW), and activating a speech recording function to record one or more inputs selected from the group consisting of the speech input and the subsequent speech input in response to the speech input being determined as a second WUW.

### CROSS-REFERENCE TO RELATED APPLICATION

This application claims priority to Chinese Application No. 201710109298.3, filed on Feb. 27, 2017, the entire contents of which are incorporated herein by reference.

### FIELD OF THE DISCLOSURE

The present disclosure generally relates to the field of voice control technology and, more particularly, to a voice control method and an electronic device.

### BACKGROUND

With the development of electronic devices, the control systems as an important component in the electronic devices, such as the voice control systems, are also continuing to progress. With the rapid development and maturity of the speech recognition technology, a variety of speech recognition software are launched into market. The interaction between a user and an electronic device becomes simple and interesting.

In order to avoid accidental operations when the user employs the speech to control the electronic device, a Wake-Up-Word (WUW) can be set. When the electronic device receives a WUW that matches the electronic device's own WUW, external voice control information can be received and, according to the voice control information, the corresponding operation can be performed.

Currently, the usage of the WUW is relatively simple.

### SUMMARY

In accordance with the disclosure, there is provided a voice control method including receiving a speech input, activating a voice control function to recognize a subsequent speech input and output a feedback corresponding to the subsequent speech input in response to the speech input being determined as a first wake-up-word (WUW), and activating a speech recording function to record one or more inputs selected from the group consisting of the speech input and the subsequent speech input in response to the speech input being determined as a second WUW.

Also in accordance with the disclosure, there is provided an electronic device including a microphone and a processor coupled to the microphone. The microphone receives a speech input. The processor activates a voice control function to recognize a subsequent speech input and output a feedback corresponding to the subsequent speech input in response to the speech input being determined as a first WUW, and activates a speech recording function to record one or more inputs selected from the group consisting of the speech input and the subsequent speech input in response to the speech input being determined as a second WUW.

### BRIEF DESCRIPTION OF THE DRAWINGS

The following drawings merely illustrate embodiments of the present disclosure. Other drawings may be obtained based on the disclosed drawings by those skilled in the art without creative efforts.

FIG. 1 is a flow chart of an example of voice control method according to the present disclosure;

FIG. 2 is a flow chart of an example of implementation method for storing converted text according to the voice control method of the present disclosure;

FIG. 3 is a flow chart of an example of implementation method for obtaining target information corresponding to a query speech from a speech input recorded using a speech recording function according to the voice control method of the present disclosure; and

FIG. 4 is a schematic diagram of an example of electronic device according to the present disclosure.

### DETAILED DESCRIPTION

In order to provide a clear illustration of the present disclosure, embodiments of the present disclosure are described in detail with reference to the drawings. It is apparent that the disclosed embodiments are merely some but not all of embodiments of the present disclosure. Other embodiments of the disclosure may be obtained based on the embodiments disclosed herein by those skilled in the art without creative efforts, which are intended to be within the scope of the disclosure.

The present disclosure provides a voice control method. The voice control method can be implemented in an electronic device, such as a smartphone, a PAD (Tablet), a PDA (Personal Digital Assistant), a PC (personal computer), a laptop, a smart TV, a smart refrigerator, a smart washing machine, or the like. The voice control method may also be implemented as an application client. Any electronic device having the application client installed thereon has the functions described in the voice control method.

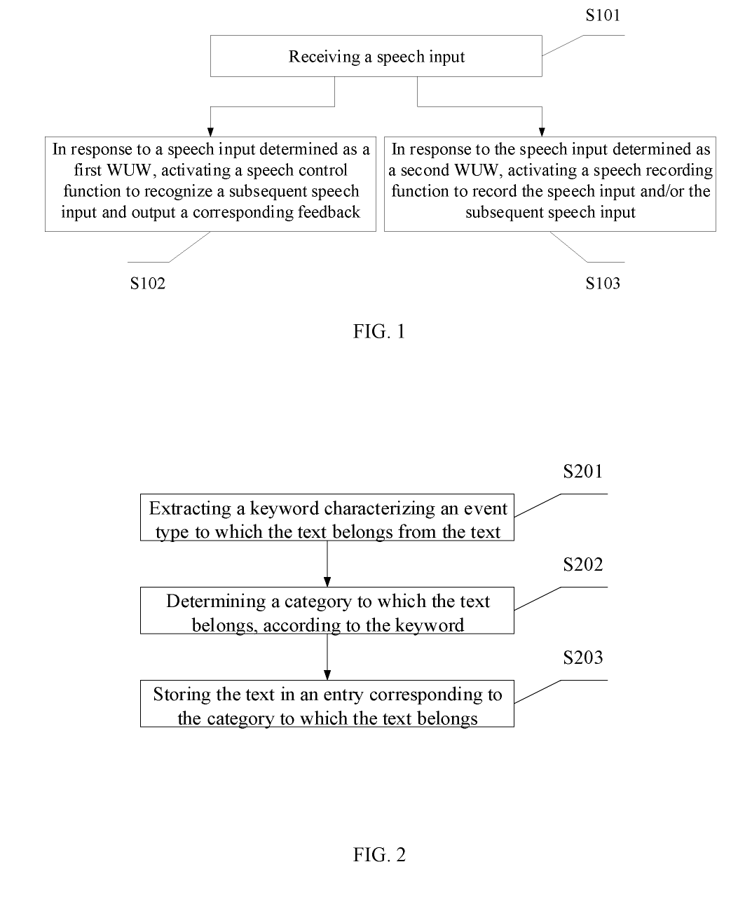

FIG. 1 is a flow chart of an example of voice control method according to the present disclosure. As shown in FIG. 1, at S101, a speech input is received.

At S102, in response to the speech input determined as a first wake-up-word (WUW), the voice control function is activated to recognize the subsequent speech input and output the corresponding feedback.

Assuming the first WUW is “Xiao Le,” when the user speaks the WUW “Xiao Le,” the electronic device is activated after receiving “Xiao Le.” The electronic device is waiting for the subsequent speech input. Upon receipt of the subsequent speech input, the subsequent speech input is recognized and, according to the recognized speech input, the corresponding control instruction can be obtained. As such, the feedback corresponding to the control instruction can be outputted.

At S103, in response to the speech input determined as a second WUW, the speech recording function is activated to record the speech input and/or the subsequent speech input.

When the user speaks the second WUW as the speech input, the speech recording function of the electronic device is activated to record the subsequent speech input. For example, the second WUW may be “record,” etc.

The subsequent speech input may be “I took the medication,” “I spent 1,000 yuan to purchase two pieces of clothing,” “Just fed the baby 130 ml formulas,” or the like.

In some embodiments, the second WUW may be a keyword for a certain event that the user needs to record using the electronic device. For example, the user who is sick needs to take medication frequently, but always forget whether or not he has took the medication, thus, “medication” may be used as the second WUW. When the speech input received at S101 is “I took the medication,” the speech recording function is activated by the speech input. Moreover, the speech input needs to be recorded. Therefore, at S103, in response to the speech input determined as the second WUW, the speech recording function can be activated to record the speech input.

In some embodiments, the speech input containing the second WUW may need to be preset and recorded in the electronic device.

When the user performs subsequent speech input, because the speech recording function has been activated, therefore, the subsequent speech input can also be recorded.

The present disclosure provides a voice control method. At least two WUWs are set for the electronic device, and each WUW can activate the corresponding operation. The electronic device receives different WUWs and then perform the corresponding operations. At least the first WUW is used to activate the voice control function to recognize the subsequent speech input and output the corresponding feedback. The second WUW is used to activate the speech recording function to record the speech input and the subsequent speech input. That is, different WUWs has different functions. The diversified use of the WUWs is achieved.

When the speech input is the second WUW, there are multiple ways of recording the speech input and/or the subsequent speech input. The embodiments of the present disclosure provide, but are not limited to, some examples as described below.

In some embodiments, the speech input and/or the subsequent speech input are stored, such as in the form of speech.

In some other embodiments, the speech input and/or the subsequent speech input are converted to text, and the converted text is stored. That is, the speech input and/or the subsequent speech input are stored in the form of text.

There are a plurality of ways for storing the converted texts. The embodiments of the present disclosure provide, but are not limited to, some examples as described below.

In some embodiments, the text is stored together in a preset entry. That is, all the text recorded by the user using the electronic device is stored together in the preset entry, such as, for example, a table, a memory space, or the like.

In some other embodiments, the text is stored according to classification.

FIG. 2 is a flow chart of an example of implementation method for storing converted text according to the voice control method of the present disclosure.

As shown in FIG. 2, at S201, a keyword characterizing an event type to which the text belongs is extracted from the text. The event type to which the text belongs corresponds to a category to which the text belongs.

For example, assume the text is “I took the medication,” then the event type of the text is “medication.” As another example, assume the text is “I purchased some rice,” then the event type of the text is “purchase.”

Through machine learning, a large number of text can be classified, and the keywords can be extracted and whether or not the keywords are correct can be determined. As such, a keyword extraction model can be established. Based on the keyword extraction model, the keyword characterizing the event type of the text can be extracted from the text.

At S202, according to the keyword, the event type of the text is determined.

At S203, the text is stored in the entry corresponding to the event type of the text.

The entry may be a table, a memory space, a document, or the like.

For example, “medication” corresponds to an entry, and “purchase” corresponds to another entry.

The present disclosure also provides an implementation method for storing the text to the entry corresponding to the event type of the text.

Identification data is retrieved from the text and stored in the entry corresponding to the event type of the text.

The identification data may include an event related price, a number of times for performing the event, an event occurrence time, an event recording time, an event related person, or one or more of items involved in the event.

The event related price refers to, during the process of the event, the price paid by the user. For example, the user speaks “I purchased a dress yesterday, which cost me 300 yuan,” then the price by performing the purchase event is 300.

The number of times for performing the event refers to how many times the event has occurred. For example, the user speaks “I took the medication three times today,” then the number of times for the taking medication event is three times.

The event occurrence time and the event recording time may be the same time or may be different times. For example, after taking the medication, the user speaks “I just took the medication,” then both the occurrence time and the recording time of the medication taking event are the current time. As another example, the user speaks “I purchased rice yesterday,” then the occurrence time of the purchase event is yesterday, and the recording time of the purchase event is the current time.

The event related person may include the person who performs the event and/or the person to/for/on whom the event is performed. For example, the user speaks “I just fed a baby 130 ml formulas,” then “I” is the person who performed the feeding event, and “baby” is the person on whom the feeding event is performed.

The items involved in the event may be, for example, the formula, the clothing, the rice, or the like.

A purchase event is described in more detail below as an example.

Assume that the user needs to record his own expenses and the entry is a table. For example, Table 1 is the table corresponding to the purchase event.

TABLE 1
The table corresponding to the purchase event

| Event recording | Event occurrence | Items involved | Event related |
|---|---|---|---|
| time | time | in the event | price |
| 13:00 | 13:00 | Rice | 30 yuan |
| Jan. 1, 2017 | Jan. 1, 2017 | | |
| 15:20 | 9:50 | Clothing | 900 yuan |
| Jan. 2, 2017 | Jan. 2, 2017 | | |
| 15:20 | 9:50 | Air conditioner | 1800 yuan |
| Jan. 3, 2017 | Jan. 3, 2017 | | |

In some embodiments, the user can query speech inputs recorded using the speech recording function. For example, in response to the speech input determined as the first WUW, the subsequent speech input can be a query speech. In this case, recognizing the subsequent speech input and outputting the corresponding feedback includes the following obtaining target information corresponding to the query speech from the speech input recorded using the speech recording function, and broadcasting or displaying the target information.

The electronic device may broadcast the target information in the form of speech, or display the target information on a display screen.

Take Table 1 as an example for illustration and assume the query speech is “The total price of the items purchased from Jan. 1, 2017 to Jan. 3, 2017,” then the electronic device can obtain a total price of 2730 yuan by calculation based at least on the “Event related price” in Table 1. The electronic device can broadcast “2370 yuan” in the form of speech or display “2370 yuan” on the display screen. The electronic device can also directly display Table 1 on the display screen.

In some embodiments, the entries containing the user's query content can be generated according to the query speech. For example, the query speech can be “The total price of the items purchased from Jan. 1, 2017 to Jan. 2, 2017,” and the electronic device can obtain 930 yuan by calculation based at least on the “Event related price” and “Event occurrence time” in Table 1. The electronic device can broadcast “930 yuan” in the form of speech or display “930 yuan” on the display screen. The electronic device can also generate Table 2 based on Table 1 and display Table 2 on the display screen, as follows.

TABLE 2
The total price of the items purchased
from Jan. 1, 2017 to Jan. 2, 2017

| Event recording | Event occurrence | Items involved | Event related |
|---|---|---|---|
| time | time | in the event | price |
| 13:00 | 13:00 | Rice | 30 yuan |
| Jan. 1, 2017 | Jan. 1, 2017 | | |
| 15:20 | 9:50 | Clothing | 900 yuan |
| Jan. 2, 2017 | Jan. 2, 2017 | | |

After the user makes the query speech, the electronic device can directly recognize the query speech and find the target information corresponding to the query speech.

In some embodiments, the query speech may be converted to query text.

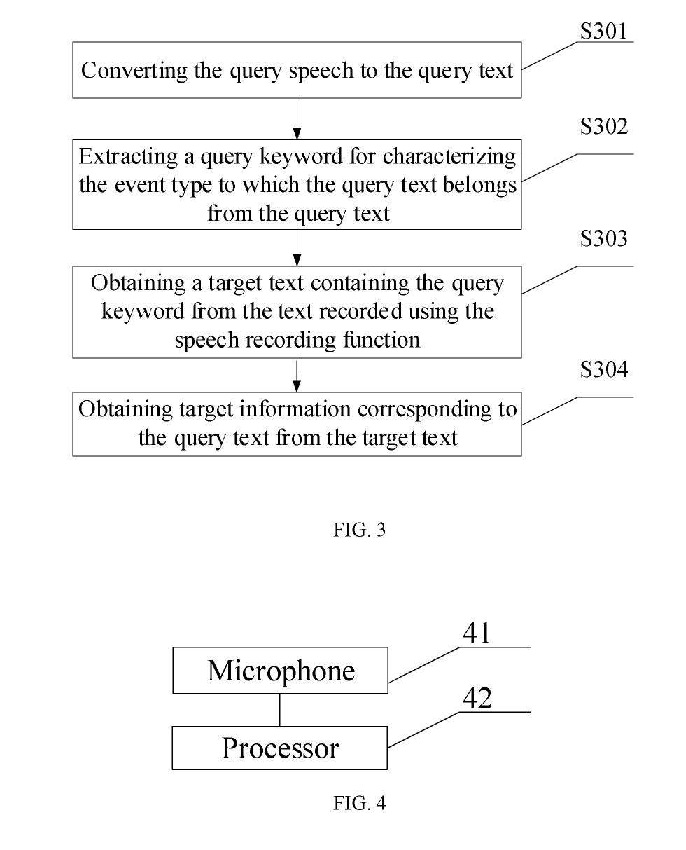

FIG. 3 is a flow chart of an example of implementation method for obtaining the target information corresponding to the query speech from the speech input recorded using the speech recording function according to the voice control method of the present disclosure.

As shown in FIG. 3, at S301, the query speech is converted to the query text.

At S302, a query keyword for characterizing the event type to which the query text belongs is extracted from the query text.

At S303, target text containing the query keyword is obtained from the text recorded using the speech recording function.

At S304, target information corresponding to the query text is obtained from the target text.

If the text recorded using the speech recording function is stored according to the classification, then at S303, the target entry whose type is the query keyword is obtained from the text recorded using the speech recording function. The target text is recorded in the target entry.

Correspondingly, at S304, question identification data for characterizing the user's query question is obtained from the query text, one or more target columns to which the question identification data belongs is determined from the target entry, and the target information corresponding to the one or more target columns is obtained according to the target entry.

The question identification data may include the event related price, the number of times for performing the event, the event occurrence time, the event recording time, the event related person, or one or more of the items involved in the event. Taking Table 1 as an example and assume the query speech is “The total price of the items purchased from Jan. 1, 2017 to Jan. 3, 2017,” then the question identification data is the price and the event occurrence time. That is, the target columns are “Event related price” and “Event occurrence time.” According to the target columns, the target information can be obtained by calculation.

The present disclosure also provides an electronic device corresponding to the voice control method. FIG. 4 is a schematic diagram of an example the electronic device according to the present disclosure. As shown in FIG. 4, the electronic device includes a microphone 41 and a processor 42.

The microphone 41 is configured to receive the speech input.

The processor 42 is configured to in response to the speech input being determined as a first WUW, activate the voice control function to recognize the subsequent speech input and output the corresponding feedback, and in response to the speech input being determined as a second WUW, activate the speech recording function to record the speech input and/or the subsequent speech input.

In some embodiments, in response to the speech input being determined as the second WUW, the processor can store the speech input and/or the subsequent speech input.

In some embodiments, when the processor records the speech input and/or the subsequent speech input, the processor can convert the speech input and/or the subsequent speech input to text, and store the converted texts.

In some embodiments, when the processor stores the converted texts, the processor can extract a keyword characterizing the event type to which the text belongs from the text, determine the event type to which the text belongs according to the keyword, and store the text in the entry corresponding to the event type to which the text belongs.

In some embodiments, when the processor stores the text in the entry corresponding to the category to which the text belongs, the processor can retrieve identification data including the event occurrence time from the text, and store the identification data in the entry corresponding to the event type to which the text belongs.

In some embodiments, the electronic device may also include a speaker or a display screen. In response to the speech input being determined as a first WUW and the subsequent speech input being the query speech, the processor can recognize the subsequent speech and output the corresponding feedback by obtaining target information corresponding to the query speech from the speech input recorded using the speech recording function, and controlling the speaker to broadcast or the display screen to display the target information.

The terms “first,” “second,” or the like in the specification, claims, and the drawings of the present disclosure are merely used to distinguish an entity or an operation from another entity or operation, and are not intended to require or indicate that there is any such physical relationship or sequence between these entities or operations. In addition, the terms “including,” “comprising,” and variants thereof herein are open, non-limiting terminologies, which are meant to encompass a series of elements of processes, methods, items, or devices. Not only those elements, but also other elements that are not explicitly listed, or elements that are inherent to such processes, methods, items, or devices. In the absence of more restrictions, the elements defined by the statement “include a/an . . . ” not preclude that other identical elements are included in the processes, methods, items, or devices that include the elements.

In the present specification, the embodiments are described in a gradual and progressive manner with the emphasis of each embodiment on an aspect different from other embodiments. The same or similar parts between the various embodiments may be referred to each other.

The implementation or usage of the present disclosure will be apparent to those skilled in the art from consideration of disclosed embodiments described above. Other applications, advantages, alternations, modifications, or equivalents to the disclosed embodiments are obvious to a person skilled in the art. The general principles defined herein may be implemented in other embodiments without departing from the spirit or scope of the present disclosure. Therefore, the present disclosure is not limited to the embodiments disclosed herein, and is intended to encompass the broadest scope consist with the principles and novel features disclosed herein.

What is claimed is:

1. A voice control method comprising:
receiving a speech input;
in response to the speech input being determined as a first wake-up-word (WUW), activating a voice control function to recognize a subsequent speech input and output a feedback corresponding to the subsequent speech input; and
in response to the speech input being determined as a second WUW, activating a speech recording function to record one or more inputs selected from the group consisting of the speech input and the subsequent speech input.

2. The method according to claim 1, wherein recording the one or more inputs includes:
directly storing the one or more inputs.

3. The method according to claim 1, wherein recording the one or more inputs includes:
converting the one or more inputs to text; and
storing the text.

4. The method according to claim 3, wherein storing the text includes:
extracting a keyword from the text;
determining an event type of the text according to the keyword; and
storing the text in an entry corresponding to the event type of the text.

5. The method according to claim 4, wherein storing the text in the entry corresponding to the event type of the text includes:
retrieving identification data from the text, the identification data including an event occurrence time; and
storing the identification data in the entry corresponding to the event type of the text.

6. The method according to claim 1, wherein:
the speech input includes the first WUW,
the subsequent speech input includes a query speech, and
recognizing the subsequent speech and outputting the feedback include:
obtaining target information corresponding to the query speech; and
controlling a speaker to broadcast the target information.

7. The method according to claim 1, wherein:
the speech input includes the first WUW,
the subsequent speech input includes a query speech, and
recognizing the subsequent speech and outputting the feedback include:
obtaining target information corresponding to the query speech; and
controlling a display screen to display the target information.

8. An electronic device comprising:
a microphone, wherein the microphone receives a speech input; and
a processor coupled to the microphone, wherein the processor:
in response to the speech input being determined as a first wake-up-word (WUW), activates a voice control function to recognize a subsequent speech input and output a feedback corresponding to the subsequent speech input; and
in response to the speech input being determined as a second WUW, activates a speech recording function to record one or more inputs selected from the group consisting of the speech input and the subsequent speech input.

9. The electronic device according to claim 8, wherein the processor further:
directly stores the one or more inputs.

10. The electronic device according to claim 8, wherein the processor further:
converts the one or more inputs to text; and
store the text.

11. The electronic device according to claim 10, wherein the processor further:
extracts a keyword from the text;
determines an event type of the text according to the keyword; and
stores the text in an entry corresponding to the event type of the text.

12. The electronic device according to claim 11, wherein the processor further:
retrieves identification data from the text, the identification data including an event occurrence time; and
stores the identification data in the entry corresponding to the event type of the text.

13. The electronic device according to claim 8, further comprising:
a speaker coupled to the processor,
wherein:
the speech input includes the first WUW,
the subsequent speech input includes a query speech, and
the processor further:
obtains target information corresponding to the query speech; and
controls the speaker to broadcast the target information.

14. The electronic device according to claim 8, further comprising:
a display screen coupled to the processor,
wherein:
the speech input includes the first WUW,
the subsequent speech input includes a query speech, and
the processor further:
obtains target information corresponding to the query speech; and
controls the display screen to display the target information.
